(19) United States
(12) Patent Application Publication
(10) Pub. No.: US 2009/0003355 A1
(43) Pub. Date: Jan. 1, 2009

(54) FRAMEWORK FOR CROSS-ECOSYSTEM AFFILIATE, VIRAL, AND WORD-OF-MOUTH ADVERTISING

(75) Inventors: Kamal Jain, Bellevue, WA (US); James Russell, Seattle, WA (US); Arun K. Sacheti, Sammamish, WA (US); Bradley W. Ward, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/768,580

(22) Filed: Jun. 26, 2007

(51) Int. Cl. H04L 12/56

(52) U.S. Cl. 370/400

(57) ABSTRACT

Systems and/or methods are presented that can employ an ad object comprising a data packet(s) to facilitate providing an advertising platform that is ecosystem independent and can support various advertising models, such as affiliate, viral, and/or word-of-mouth (WOM) advertising. The data packet can be associated with an advertisement for a product(s) and/or service(s) and can include a mechanism(s) that facilitates enabling users to reproduce the data packet and associated advertisement in different sites, such as user sites. As the data packet propagates through a community network, the data packet can receive and accumulate data, such as data relating to purchases, comments, or ratings, storing such data in the data packet and displaying a portion of such data with the advertisement to facilitate WOM advertising. The data packet facilitates providing incentives to users who perform desired actions (e.g., purchases, syndication) related to the advertisement.

### BACKGROUND

Computing and network technologies have transformed many aspects of everyday life, including how business is performed. As computing and network technologies have evolved and have become more robust, secure and reliable, more consumers, wholesalers, retailers, service providers, entrepreneurs, educational institutions and the like are shifting paradigms and are employing the Internet to perform business in addition to traditional means. For example, merchants and service providers can use online advertisements to sell or promote their products or services either through their own web sites, e-mail or other electronic message advertising, and/or advertisements that can appear on web sites or blogs of third parties.

Conventionally, systems have been bound to a particular ecosystem or have included a limited set of advertising models. Such systems can place limitations on the business models available to advertisers as well as the number of users that can be targeted by advertisers. It is desirable for advertisers to have greater flexibility in their advertising models as well as the ability to reach a greater target audience. Further, it is desirable to have an advertising platform that is not bound by a particular ecosystem.

### SUMMARY

The following presents a simplified summary in order to provide a basic understanding of some aspects of the disclosed subject matter. This summary is not an extensive overview of the disclosed subject matter and is not intended to identify key/critical elements or to delineate the scope of such subject matter. Its sole purpose is to present some concepts in a simplified form as a prelude to the more detailed description that is presented later.

Systems and/or methods are presented that can employ an ad object comprising a data packet(s) to facilitate providing an advertising platform that is ecosystem independent and can support various advertising models, such as affiliate, viral, and/or word-of-mouth (WOM) advertising. In accordance with one aspect of the disclosed subject matter, an ad object can be included that can be transferred and/or reproduced in sites (e.g., web sites, blogs, e-mails, etc.) to advertise a product(s) and/or service(s), motivate users to take primary actions (e.g., purchases, downloads, other actions desired by an advertiser) with regard to the product/service advertised, track and collect data relating to user activity (e.g., viewing, making purchases, providing comments or ratings, etc.) associated with the ad object, and/or provide incentives to users who perform actions (e.g., primary actions, syndication actions) desired by an advertiser with regard to the ad object.

The ad object can be comprised of a data packet (e.g., a piece of code), and/or associated data packets, and can include content associated with an advertisement. Such content can include viral content (e.g., video), promotional content (e.g., photo, description), and/or community metadata (e.g., ratings, reviews, comments, etc.) that can be associated with the advertisement. The data packet can receive and accumulate data associated with advertisements and users, as well as other data, and such data can be added to the data packet as the packet propagates through a network.

The data packet can receive and accumulate data associated with primary actions and can facilitate completion of the primary actions, as the data packet and associated ad object can enable a user to perform a primary action via the ad object while within the site that is hosting the ad object; that is, a primary action can be completed without the user being directed to another site, so the user can remain on the host site. Further, the ad object can include mechanism(s) that enable a user to provide community metadata to the ad object and can receive data associated with community actions, such as actions where a user manipulates (e.g., mouse clicks) the ad object to provide community metadata, can include such community metadata in the data packet associated with the ad object, and/or can display such community metadata with the advertisement associated therewith. The ad object can also include mechanism(s) that can facilitate the syndication of the ad object through a community network (e.g., on a web site, blog, e-mail, etc.), can receive information relating to syndication actions, and/or can process such syndication actions.

The data packet can also include object metadata that can include information regarding the referral chain associated with the ad object, so that the path of the data packet can be charted as it proceeds through the community network from its original seeding point to a current instance; information regarding the lifespan of the data packet; and/or information regarding the incentive provided by the advertiser to motivate users to perform certain actions (e.g., providing a discount to a user if the user purchases the advertised product). Further, the data packet and ad object can facilitate providing an incentive to a user, such as by providing and displaying an incentive (e.g., discount coupon) to a user via the ad object.

The disclosed subject matter can also include a central service component (also referred to herein as “CSC”) that can track user activity with regard to one or more ad objects, which can be displayed and/or embedded in host sites in a community network, and can facilitate providing incentives to users and/or collecting intelligence regarding consumers based in part upon user activity data and/or other data (e.g., contextual information) associated with the ad object(s).

To the accomplishment of the foregoing and related ends, certain illustrative aspects are described herein in connection with the following description and the annexed drawings. These aspects are indicative of various ways in which the disclosed subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates a block diagram of a system that facilitates marketing of products and/or services in accordance with the disclosed subject matter.

FIG. 2 depicts a block diagram of a system that facilitates collecting data to facilitate marketing of products and/or services in accordance with the disclosed subject matter.

FIG. 3 illustrates a block diagram of another system that facilitates marketing of products and/or services in accordance with the disclosed subject matter.

FIG. 4 illustrates a block diagram of a system that facilitates communication with a community network to facilitate marketing of products and/or services in accordance with the disclosed subject matter.

FIG. 5 depicts a block diagram of a system that employs intelligence to facilitate marketing of products and/or services in accordance with the disclosed subject matter.

FIG. 6 illustrates a block diagram of a system that facilitates marketing of products and/or services in accordance with the disclosed subject matter.

FIG. 7 is a representative flow diagram illustrating a methodology that facilitates marketing of products and/or services in accordance with an aspect of the disclosed subject matter.

FIG. 8 is a representative flow diagram depicting a methodology that facilitates syndicating an ad object in accordance with the disclosed subject matter.

FIG. 9 is a representative flow diagram illustrating a methodology that facilitates distributing an incentive associated with a syndication action to a syndicating user in accordance with the disclosed subject matter.

FIG. 10 is a representative flow diagram illustrating a methodology that facilitates distributing an incentive associated with a primary action to a user-affiliate in accordance with the disclosed subject matter.

FIG. 11 is a representative flow diagram illustrating a methodology that facilitates marketing products and/or services in accordance with the disclosed subject matter.

FIG. 12 is a representative flow diagram illustrating a methodology that facilitates receiving and utilizing community metadata to facilitate marketing products and/or services in accordance with the disclosed subject matter

FIG. 13 is a schematic block diagram illustrating a suitable operating environment.

FIG. 14 is a schematic block diagram of a sample-computing environment.

### DETAILED DESCRIPTION

The various aspects of the disclosed subject matter are now described with reference to the annexed drawings, wherein like numerals refer to like or corresponding elements throughout. It should be understood, however, that the drawings and detailed description relating thereto are not intended to limit the disclosed subject matter to the particular form disclosed. Rather, the intention is to cover all modifications, equivalents, and alternatives falling within the spirit and scope of the disclosed subject matter.

As used in this application, the terms “component,” “system,” “store,” “interface,” and the like are intended to refer to a computer-related entity, either hardware, a combination of hardware and software, software, software in execution, and/or firmware. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over the other aspects or designs.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but is not limited to magnetic storage devices (e.g., hard disk, floppy disk, magnetic strips . . . ), optical disks (e.g., compact disk (CD), digital versatile disk (DVD . . . )), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Advertisers (e.g., including merchants, wholesalers, retailers, etc.) have increasingly turned to the Internet and the online community to market their products and services to users in the network. Advertisers desire to expand their user base to be able to reach a greater number of users with the advertising, while at the same time utilizing certain advertising models, such as word-of-mouth (WOM) advertising, to better target their advertising by taking advantage of the influence that certain users may have over other users. Conventionally, systems have been bound to a particular ecosystem or have included a limited set of advertising models. Such systems can place limitations on the business models available to advertisers as well as the number of users that can be targeted by advertisers. It is desirable for advertisers to have greater flexibility in their advertising models as well as the ability to reach a greater target audience. Further, it is desirable to have an advertising platform that is ecosystem independent and can support various advertising models, such as affiliate, viral, and/or WOM advertising.

Systems and/or methods are presented that can employ an ad object comprising a data packet(s) to facilitate providing an advertising platform that is ecosystem independent and can support various advertising models, such as affiliate, viral, and/or word-of-mouth (WOM) advertising. The ad object can include a mechanism(s) that can facilitate reproducing the ad object in different sites and can display advertising associated with products and/or services. The ad object can receive data, such as data relating to purchases, comments, ratings, reviews, and can store such data in the data packet as well as display such data with the advertising content in order to facilitate WOM advertising of the advertised product/service. The ad object can also facilitate rewarding users who perform actions (e.g., purchases, downloads) related to the advertisement that can be desired by an advertiser.

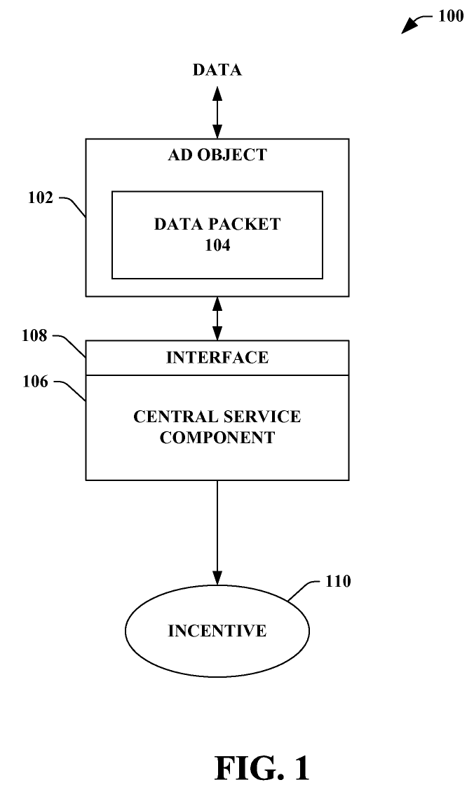

Turning now to FIG. 1, depicted is an illustration of a system 100 that facilitates marketing of products and/or services in accordance with the disclosed subject matter. In accordance with one aspect of the disclosed subject matter, a system 100 can include an ad object 102 that can be comprised of a data packet 104 (e.g., a piece of code), or a number of associated data packets 104, that can include an advertisement that can market product(s) and/or service(s), and/or can present other information. The ad object 102 can be seeded or embedded in an initial site (e.g., web site, blog, e-mail, etc.) and can be reproduced via a syndication action by a user and such reproduced ad object 102 can then be embedded and/or displayed in another site, as desired by the user. Also, the ad object 102 can facilitate the performance of primary actions (e.g., purchases, downloads, etc.) by users who can perform a primary action, as provided by the ad object 102, via the ad object 102 while still on the site hosting the ad object 102, without being re-directed to another site to complete the primary action.

The data packet 104 can include content associated with the advertisement, such as viral agents, which can include any content or services that can motivate a publisher-user to host the ad object 102 in their site, as well as motivate a user to purchase or perform some other primary action associated with the advertisement. For example, the content can be an interesting video that may capture the attention of users and thus attract them to the publisher's site and/or attract them to the product/service marketed by the advertisement. The data packet 104 can also include other promotional content, such as a photograph or product/service description, that can be provided by the advertiser to the publisher to facilitate promoting the product/service.

The data packet 104 can further include community metadata, which can include, for example, reputation, ratings, reviews, comments, and/or tagging information related to the product/service marketed by the advertisement. The community metadata can be received by the ad object 102 from users in the community network who can provide such metadata by manipulating (e.g., by mouse click, keystroke, voice command, etc.) the ad object 102 and submitting the community metadata. The community metadata can be added to the data packet 104 of the ad object 102, as the ad object 102 and associated data packet 104 propagate through the community network.

The ad object 102 can also include mechanisms to facilitate enabling users to perform primary actions, community actions (e.g., submitting reviews, ratings, etc.), and/or syndication actions associated with the advertisement. The ad object 102 can include a primary-action control, and the data packet 104 can include code associated therewith, that can facilitate enabling a user to perform a primary action via the ad object 102 while still on the host site, without re-directing the user to another site. For example, a user can view an advertisement associated with the ad object 102 and can manipulate the primary-action control to initiate performing a primary action. If the user is not already authenticated and logged into a community network, the user can be requested to authenticate a common identity service, so that the user can be identified and authenticated. Once the user is identified and authenticated, the ad object 102 can receive data associated with the primary action from the user, and can add such data to the data packet 104. Further, the ad object 102 can facilitate providing such data to a central service component 106 (hereinafter also referred to as “CSC 106”) via interface component 108 (each described more fully herein). The primary action can be processed via the ad object 102 while the user remains on the site hosting the ad object 102, without the user being re-directed to another site, such as the advertiser's web site. In accordance with another embodiment of the disclosed subject matter, when a primary action is initiated by manipulating a primary action control, the user can be re-directed to another site, such as the advertiser's web site, to process the primary action.

The ad object 102 can also include a community control, and the data packet 104 can include code associated therewith, that can facilitate enabling users to perform community actions (e.g., provide community metadata) relating to the product/service advertised by manipulating the community control and submitting community metadata to the ad object 102, where the received community metadata can be added to the data packet 104 and can be displayed by the ad object 102. Further, the ad object 102 can facilitate providing such data to CSC 106 via interface component 108.

In accordance with one embodiment of the disclosed subject matter, the ad object 102 can further include a syndication control, and the data packet 104 can include code associated therewith, that can facilitate enabling a user to perform a syndication action with regard to the ad object 102 in order to reproduce or copy the ad object 102 and data packet 104 in a site, as desired by the user, such as, for example, the user's blog. For example, a user can view the advertisement and associated ad object 102 on a site of another user and can manipulate a syndication control that can be included with the ad object 102 to perform a syndication action to reproduce the ad object 102 on a site associated with the syndicating user.

In accordance with another embodiment of the disclosed subject matter, the syndication of an ad object 102 can be facilitated by an ecosystem (not shown) that can include a control or mechanism that can facilitate reproducing an ad object 102 in a site of a user who is syndicating the ad object 102. For example, an ecosystem can be a web site associated with a merchant, an online service provider, and/or other entity, and can include one or more ad objects 102. The ecosystem can include a control or mechanism that enables a user to syndicate an ad object(s) 102 to reproduce the ad object(s) 102 and associated data packet 104 within a site associated with the syndicating user. As further example, the syndicating user can manipulate the control of the ecosystem to reproduce the ad object 102 on the user's web site or blog, and/or to have the ecosystem generate an e-mail or instant message that can have the ad object 102 reproduced therein, and the e-mail or instant message can be sent to another user(s) to whom the syndicating user specifies in the e-mail or instant message.

In accordance with still another embodiment of the disclosed subject matter, the syndication of an ad object 102 can be facilitated by a browser (not shown) that can include a control or mechanism that can facilitate enabling a user to syndicate an ad object(s) 102 to reproduce or copy the ad object(s) 102 and associated data packet 104 within a site of the user syndicating the ad object(s) 102. For example, the browser can include a copy function or other mechanism that can enable the user to copy the ad object 102 and its content (e.g., data packet 104) and paste the ad object 102 and content into a site associated with the user to syndicate the ad object 102.

In accordance with yet another embodiment of the disclosed subject matter, the syndication of an ad object 102 can be facilitated by an application (not shown) that can include a syndication control or mechanism that can reproduce an ad object 102 and associated information (e.g., contained in data packet 104) on a site of a syndicating user. For example, an application can be an online mail application that can facilitate forwarding messages, such as e-mails, to other entities (e.g., users). A user can receive an ad object 102 in a message, and can syndicate the ad object 102 by forwarding the message, including the ad object 102, to another user(s). As another example, an application can include a control or mechanism (e.g., copy function) that can facilitate copying the ad object 102, including associated data (e.g., data packet 104), and pasting the ad object 102 in another form of electronic communication (e.g., web site, blog, e-mail, instant message, etc.) to syndicate the ad object 102.

When a syndication action is performed, the syndicating user, who can be identified as a result of authenticating via a common identity service, can be associated with a unique token that can identify the user and the user's site, for example, so the syndicating user can be identified and can be can be given credit for a conversion if another user makes a purchase via the advertisement on the syndicating user's site. Data associated with such syndication action can be added to the data packet 104 as object metadata, as more fully described herein. Further, the ad object 102 can facilitate providing such data to CSC 106 via interface component 108.

In accordance with one embodiment of the disclosed subject matter, when an ad object 102 and associated data packet 104 are reproduced in another site, the data contained in the data packet 104 can be copied to the new site, and additional data associated with the syndication action can also be added to the reproduced data packet 104. The data packet 104 can host the data stored in the packet 104. Thus, the data packet 104 on the original site will still contain the data it had prior to the syndication action. That data packet 104 on the original site can also add information indicating that a syndication action was performed thereon. The reproduced data packet 104 can include all the data from the data packet 104 on the original site and can also accumulate and contain data associated with the syndication action, such as data regarding the syndicating user (e.g., unique token identifier), the location where it was reproduced, etc.

In accordance with another embodiment of the disclosed subject matter, the CSC 106 can host the data associated with the data packet 104. Data can be received by the data packet 104 and provided to CSC 106, which can provide a reference number to the data packet 104, where the reference number can be utilized to identify the data and/or where to locate such data. For example, during a syndication action, when the data packet is reproduced on the site of the user, the data of the data packet 104 can be copied to the CSC 106, which can provide the reproduced data packet 104 a reference number that can be stored in the data packet and can be used to identify and/locate such data when the reproduced data packet 104 desires such data.

The ad object 102 can include and/or can receive object metadata related to the referral chain of the ad object 102 and data packet 104, the packet lifespan, and/or incentives 110 associated with the ad object 102. The data packet 104 can receive data associated with the path the data packet 104 has taken as it is propagated through the community network from the original seeding point of the data packet 104 through its current location. The referral chain data can include data that can identify each site the ad object 102 has been located, the identity of users who have performed an action(s) (e.g., primary, community, and/or syndication action) with regard to the ad object 102, the type of action that was performed, the time the action was performed, etc.

The data packet 104 can also include object metadata related to the lifespan of the data packet 104. A data packet 104 can have a limited lifespan, as desired, where the lifespan can be restricted based on time, referral depth, and/or the number of actions, for example. To further illustrate, a data packet 104 can be limited to a predetermined period of time (e.g., one month). Once the data packet 104 has reached its time limit, the offer of an incentive can expire.

Also, the referral depth can be limited to a predetermined number of referrals (e.g., six referrals). For example, a particular data packet 104 may only be able to be reproduced and located in a different site a limited number of times. Once the referral chain limit has been reached, the data packet 104 cannot be reproduced into another site. The referral chain limit can refer to the chain the particular data packet 104 takes. That is, if a data packet 104 is seeded at site A, and has a referral chain limit of two referrals per chain, such data packet 104 is zero deep in the referral chain and may be reproduced into other sites, since the data packet 104 at site A will have zero referrals. If a data packet 104 is located at site A, where it is reproduced at site B, and then is located at site B and reproduced into site C, then that data packet 104 has reached its referral chain limit of two, and the data packet 104 located on site C can not be reproduced; however, the data packet 104 located at site B can still be reproduced into site D, since the data packet 104 at site B was only one referral deep into the referral chain.

Further, the number of actions can be limited to a predetermined number, where the restriction can be with regard to respective individual types of actions and/or a total number of all types of actions. For example, the number of syndication actions associated with a data packet 104 can be limited to a predetermined number. Thus, while a data packet 104 in a referral chain may not be at a limit on a particular site, the data packet 104 may still be limited to a specified number of actions, and when such limit is reached, the data packet 104 and associated ad object 102 can not be reproduced to another site.

Further, data packet 104 can include object metadata related to the incentive(s) 110 that can be provided to users in response to the performance of certain actions by users. Such metadata can include the type of incentive 110 (e.g., monetary, reward points, discount amount or percentage, etc.), and/or the amount of incentive 110, which can be based on the type of action performed by a user. The ad object 102 can facilitate providing the incentive 110 to the user and/or can facilitate communicating data associated with an action of a user to the CSC 106, which can then determine an appropriate incentive 110 and can provide the incentive 110 to the user.

The ad object 102 can provide a copy of data contained in the data packet 104 to the CSC 106, which can receive a copy of such data via an interface component 108 (e.g., discussed infra) to facilitate processing primary actions being performed by users, determining an amount and/or type of incentive 110 that can be awarded a user for performing actions desired by advertisers and/or for conversions, gaining information regarding users to learn about users in order to facilitate better targeting of advertisements to users, the interests of users, etc.

For example, in accordance with an aspect of the disclosed subject matter, a user can authenticate via a common identity service, so that the user can be identified in the community network. The user can see an advertisement and associated ad object 102 for a video game on a web site. The advertisement has an interesting video that shows a simulation of the video game, and states that a purchase of the game through the advertisement can be made with a $20.00 discount that can be immediately redeemable. The user is interested in the game with the immediate price discount and decides to purchase the game, so the user clicks on the primary-action control associated with the ad object 102. The data associated with such action can be received by the data packet 104 associated with the ad object 102. Further, the purchase can be completed via the ad object 102 while the user remains on the site. The data received by the data packet 104 can be provided to CSC 106 which can facilitate completing the purchase of the user and can provide the discount.

The user receives the game and really likes it. The user remembers that the advertisement had another offer, where if the user posts the advertisement on the user's site, the user can be awarded $3.00 for each conversion (e.g., purchase) made through the advertisement posted on his site; plus, the user remembers that the advertisement had an interesting video about the game. The user decides to put the advertisement on his blog, and initiates a syndication action to reproduce the ad object 102 on his blog. Further, during the syndication action, the user decides to share his experience regarding the game, and posts a message with the advertisement stating how much he enjoys the game and that he recommends it. The data relating to the syndication action including the comments of the user can be added to the data packet 104 and the comments can be displayed with the advertisement on the user's blog. Further, a token that uniquely identifies the user can be associated with the user, and such information can be added to the data packet 104.

A second user, who is logged into the network, sees the advertisement on the first user's blog and is interested in the video game with the price discount. The second user purchases the game via the ad object 102 on the first user's blog. The data packet 104 can receive the data regarding the purchase, which can be added to the data packet 104. Further, such data, and data identifying the first user (e.g., token identifier), who is now an affiliate, can be provided to CSC 106 where the purchase can be completed at the discount price, and the first user-affiliate can be awarded $3.00 for the conversion, which can be deposited in the account associated with the first user.

The second user receives the game, and she likes it. She decides to go back to the first user's blog and write a comment about the game and give it a rating, and so she goes back to the first user's blog and clicks on a “comments/ratings” button in the advertisement. The “comments/ratings” button can be associated with a community control, and clicking on the button can initiate a community action. The comment and rating (e.g., community metadata) made by the second user can be received by the ad object 102 on the first user's blog, and such community metadata can be added to the data packet 104 as well as displayed with the advertisement in the first user's blog.

As another example, in accordance with an aspect of the disclosed subject matter, a user can read an article related to politics from an online newspaper. The article can be located within a particular ecosystem, such as on a web site of the online newspaper, within a community network. The user is interested in the article because the user is interested in politics and has a political blog on which he posts news related to politics as well as his comments regarding such news. Below the article is an advertisement associated with the article that includes an ad object 102 (and included data packet 104). The advertisement offers the user an incentive of 500 reward points for syndicating the advertisement related to the article, where the advertisement can include a portion or summary of the contents of the article. Further, the advertisement offers a sale conversion incentive of $1.00 for each article sold via an advertisement posted on the user's blog.

Since the user is interested in the subject matter of the article and would like to blog about it, and further, since there can be an incentive to post the advertisement on his blog, the user decides to syndicate the advertisement and become an affiliate of the advertiser. The user performs a syndication action to reproduce the article in the user's blog. The ad object 102 also prompts and invites the user to blog his comments regarding the article. The user makes his comments regarding the article, and an advertisement that includes a portion or summary of the article and the user's comments are copied to the user's blog. Such syndication information, including a token identifier that identifies the user, and comments are also added to the data packet 104. The data packet 104 also shared the syndication information with CSC 106, which evaluates the received information and awards the user 500 reward points for completing the syndication, and the points are deposited in the account of the user. The user's blog is not within the particular ecosystem from which the user obtained the article.

Another user views the article excerpt in the user's blog and is interested in the article herself She decides to purchase the article via the advertisement and associated ad object 102 on the user's blog. The other user clicks on the primary-action control (e.g., button indicating “Purchase This Article”) associated with the ad object 102 and the sale of the article can be completed while the purchaser remains on the affiliate's blog. The data packet 104 can receive the information regarding the conversion, which can be added to the data packet 104. Further, the data packet 104 can share this information with the CSC 106 to facilitate processing the purchase. Once the sale of the article has been processed, the CSC 106 can evaluate the data associated with the conversion, and can determine that the user-affiliate has earned $1.00 based on the conversion, and can deposit $1.00 into the account of the user.

It is to be appreciated that an ad object 102, associated data packet 104, and/or an advertisement associated therewith, can be included in a host site or container, such as a web site, a web page, a blog, an online subscription service, a webfeed, an e-mail, an instant message, short message service (SMS), enhanced messaging service (EMS), multimedia messaging service (MMS), and/or other electronic communication that can be made from a user to another person (e.g., another user) or entity.

Further, promotional content can include, for example, product screenshots, box shots, videos, descriptive information, and/or hyperlinks to another online location (e.g., web site, web page) where the aforementioned promotional content can be perceived. Further, promotional content can be a viral agent, such as a promotional trailer for a product and/or service.

A primary action can include, for example, with regard to the product or service marketed by the advertisement, making a purchase of the product or service, sampling the product or service (e.g., test drive a car, free trial of a product or service), downloading software associated with the product or service, registering for the product or service (whether free or as a purchase), filling out a form or survey associated with the product or service, making an appointment associated with the product or service, etc.

Turning back to interface 108, the system 100 can include any suitable and/or necessary interface component 108 (also herein referred to as “interface 108”), which can provide various adapters, connectors, channels, communication paths, etc. to integrate the CSC 106 into virtually any operating and/or database system(s) and/or with one another system(s). In addition, the interface component 108 can provide various adapters, connectors, channels, communication paths, etc., that can provide for interaction with the CSC 106, and/or any other component, data and the like associated with the system 100.

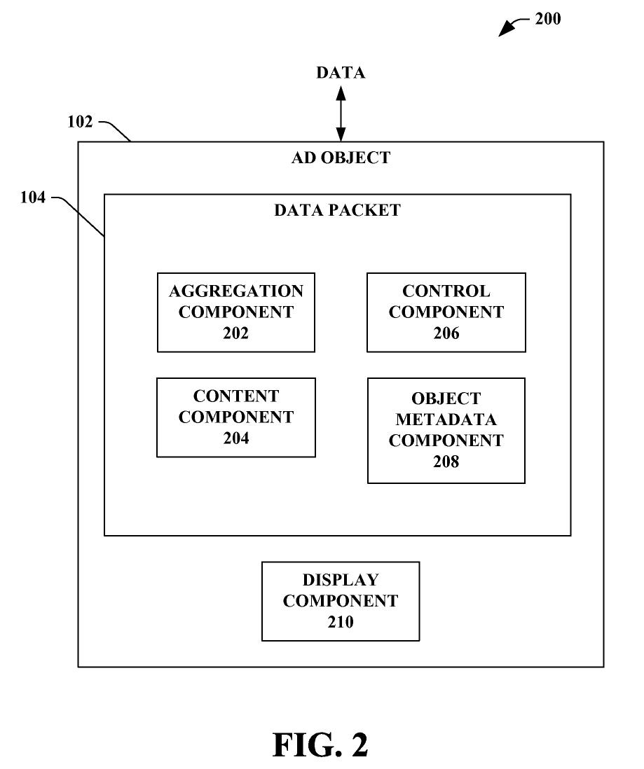

Referring to FIG. 2, illustrated is a system 200 that facilitates collecting data related to a user in order to facilitate marketing products and/or services in accordance with the disclosed subject matter. System 200 can include an ad object 102 that can receive data associated with users, user activity, advertisements, products, services, primary actions, community actions, syndication actions, object metadata, and/or other data. The ad object 102 can include a data packet 104 that can contain the received data, and can facilitate marketing of products and/or services, propagating through a community network and/or through ecosystems to promote the associated products/services, processing transactions (e.g., primary actions) associated with the products/services, accumulating information regarding users to better target advertising, etc. The ad object 102 and data packet 104 can each function as more fully described herein, for example, with regard to system 100.

The data packet 104 can include an aggregation component 202 that can aggregate and/or organize the data received by the ad object 102 in order to facilitate processing transactions associated with actions performed by users; determining an amount and/or type of incentive that can be awarded to a user; learning more about users to better target advertising; etc. The aggregation component 202 can filter, select, and/or organize the data received by the ad object 102. For instance, the aggregation component 102 can identify portions of data that can be community metadata and can add such community metadata to the data packet 104, and/or to an appropriate part of a data string therein. It is to be appreciated that the aggregation component 202 can be incorporated into the data packet 104 (as depicted), a stand-alone component, incorporated into a search component (not shown) that enables the browsing of data, and/or most any suitable combination thereof.

The data packet 104 can include a content component 204 that can include data, including code, that can be associated with or represent content associated with an advertisement of a product or service. The content component 204 can include data associated with a viral agent, which can be any content or services that can motivate a user to publish or host the data packet 104 on the user's site. For example, a viral agent can be an interesting video related to the product or service. The content component 102 can also include promotional content that can include, for example, product screenshots, box shots, videos, descriptive information, and/or hyperlinks to another online location (e.g., web site, web page) where the aforementioned promotional content can be perceived. Further, promotional content can be a viral agent, such as a promotional trailer for a product and/or service. The promotional content can be material, in the form or data (e.g., code), that can be provided by an advertiser to promote the product or service.

Content component 204 can also include community metadata, which can include data associated with reputation, ratings, reviews, comments, and/or tagging information that can be associated with users, products, and/or services, and can be added to the data packet 104 as the data packet 104 propagates through the community network. For example, a user can submit comments regarding a product by manipulating a community control associated with the ad object 102 and typing in the desired comments. Such comments can be added to the data packet 104 and can also be displayed with the associated advertisement.

Data packet 104 can further include a control component 206 that can include controls to facilitate the performance of actions by users. The control component 206 can include a primary-action control that can facilitate enabling users to perform primary actions (e.g., purchases, downloads, etc.) associated with an advertisement. The control component 206 can also include a community control that can facilitate enabling a user to submit community metadata associated the advertisement, and can facilitate adding such community metadata to the data packet 104. Further, the control component 206 can include a syndication control that can facilitate enabling a user to perform a syndication action to reproduce an ad object 102 and associated data packet 104 in another location (e.g., web site, blog, instant message, etc.) to facilitate propagating the ad object 102 and data packet 104 through the community network.

Also, the data packet 104 can include an object metadata component 208 that can facilitate adding and/or tracking metadata associated with the ad object 102. The object metadata component 208 can maintain a referral chain that can chart the path taken by the ad object 102 and data packet 104 through the community network, including each location the ad object 102 has been embedded from its original seeding point through the current location. The object metadata component 208 can identify the users that have syndicated and published such ad object 102 and can associate each syndicating user with a unique token identifier that can be used to identify such user. Such metadata can be added to the data packet 104.

The object metadata component 208 can also facilitate adding and/or tracking metadata associated with the lifespan of the data packet 104. A data packet 104 can have a limited lifespan, as desired, where the lifespan can be restricted based on time, referral depth, and/or the number of actions, for example. The object metadata component 208 can receive data, which can be added to the data packet 104, to track an amount of time that has elapsed, since a data packet 104 has been first embedded and/or has been syndicated, and can have information regarding a predetermined time limit that may be imposed on the data packet 104.

The object metadata component 208 can also track the referral depth and can have information relating to a predetermined referral chain limit that may be imposed on the data packet 104. The referral chain amount can increment each time an ad object is reproduced in another location, and metadata regarding such referral or syndication can be added to the data packet 104.

The object metadata component 208 can also receive data related to and/or can track the number of respective actions (e.g., primary, community, and/or syndication actions) that have been performed related to the data packet 104. There can be predetermined limits placed on a certain type of actions, such as, for example, a limit on the number of syndication actions that can be performed in relation to the ad object 102 and data packet 104. The object metadata component 208 can also include information regarding a limit on the amount of community metadata to be displayed with an advertisement and/or the length of time such community metadata is to be displayed with the advertisement. For example, a limit can be placed on community metadata such that only comments received in the past thirty days can be displayed with the advertisement, although the data packet 104 can still contain all community metadata received regardless of when received.

Further, the object metadata component 208 can include data associated with incentives that can be awarded to users to motivate users to perform actions desired by advertisers. The object metadata component 208 can include incentive data related to one or more types of incentive and/or one or more incentive amounts.

The ad object 102 can include a display component 210 that can facilitate displaying content, controls, and/or metadata (e.g., community, object), etc., associated with the data packet 104. The display component 210 can be a graphical user interface (GUI) and/or can be associated with a GUI in order to facilitate displaying such content, controls, and/or metadata, etc. It is to be appreciated that the display component 210 can be incorporated into the ad object 102 (as depicted), a stand-alone component, and/or most any suitable combination thereof.

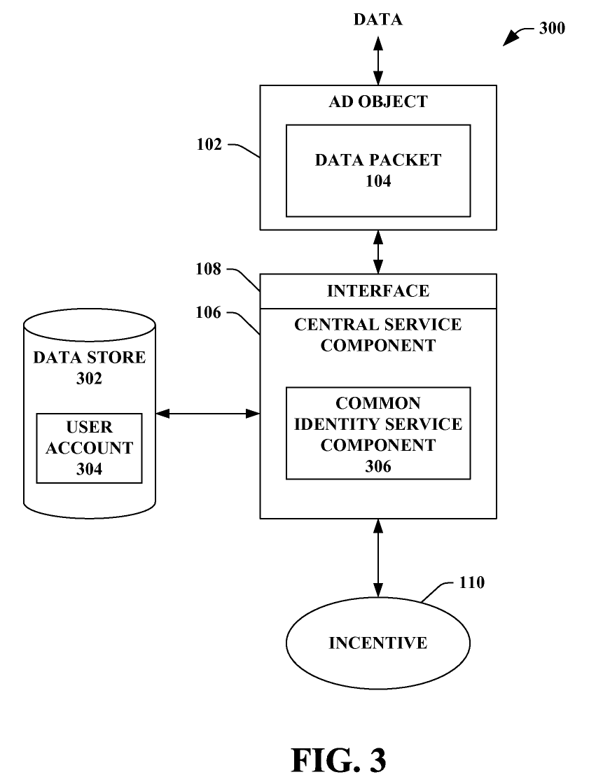

Turning to FIG. 3, depicted is a system 300 that facilitates marketing product(s) and/or service(s) in accordance with the disclosed subject matter. System 300 can gather data associated with users, user activity, advertisements, products, services, primary actions, community actions, syndication actions, object metadata, and/or other data. System 300 can include an ad object 102 and data packet 104, which can receive such data, and such data can be stored in data packet 104. Such data can also be provided by the data packet 104 to the CSC 106 via interface 108.

More particularly, the data packet 104 can facilitate affiliate, viral, and/or WOM advertising in an ecosystem independent environment, such that the data packet 104 can be propagated throughout a community network thereby facilitating advertising products and/or services, actions associated with advertisements, providing incentives 110 to users who perform desired actions (e.g., primary actions), gaining data regarding users that can be used to better target advertising, etc. The ad object 102, data packet 104, CSC 106, and interface 108 can each respectively function as more fully described herein, for example, with regard to system 100 and/or 200.

CSC 106 can be associated with a data store 302 that can store any suitable data (e.g., information) associated with users, user activity, advertisements, products, services, primary actions, community actions, syndication actions, object metadata, etc., including, for example, data that can be received by the ad object, 102, data packet 104, and/or CSC 106, as more fully described herein, for example, with regard to system 100. The data store 302 also can facilitate storing information associated with a user in a user account 304 associated with the user, and the user account 304 can be stored in data store 302.

CSC 106 can also include a common identity service (CIS) component 306 that can receive authentication information from one or more users to identify a particular user and verify (e.g., authenticate) a particular user, so that the identity of a particular user can be reasonably known by CSC 106. The CIS component 306 can request a user to authenticate, for example, when the user attempts to manipulate (e.g., mouse click, keystroke, voice command, etc.) an ad object 102, and/or associated controls, associated with an advertisement for a product or service, primary actions, community actions, syndication actions, etc.

The CIS component 306 can facilitate storing information in user account 304 that can be associated with a respective user, as the CIS component 306 can identify the respective user, so that the data store 302, the ad object 102, data packet 104, CSC 106, and other components can know which user account 304 is to be accessed when sending data to or receiving data from data store 302, and/or associating data with the user account 304 when data is stored in data store 302.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 304 of the subject systems and methods is intended to comprise, without being limited to, these and any other suitable types of memory. In addition, it is to be appreciated that the data store 302 can be a server, a database, a hard drive, and the like.

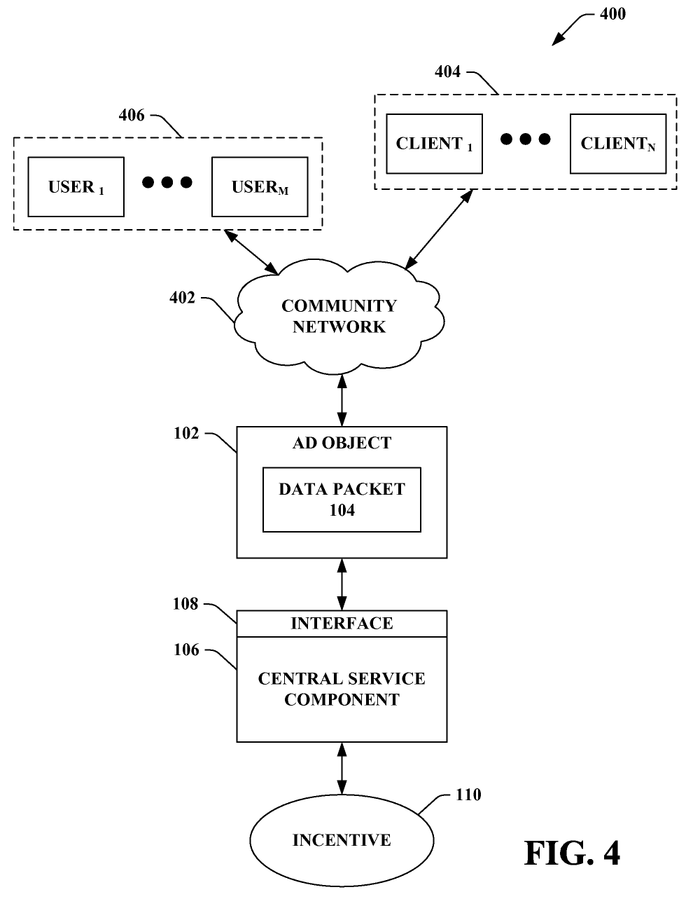

Turning to FIG. 4, depicted is a system 400 that can facilitate gleaning data associated with a community network in order to facilitate marketing products and/or services in accordance with the disclosed subject matter. The system 400 can include an ad object 102, and data packet 104 that can be included therein, that can receive data associated with users, user activity, advertisements, products, services, primary actions, community actions, syndication actions, object metadata, and/or other data. The ad object 102 can be associated with CSC 106, which can receive data from the ad object 102 and data packet 104 via interface 108.

Data packet 104 can accumulate such data and can facilitate advertising products and/or services, actions associated with advertisements, providing incentives 110 to users who perform desired actions (e.g., primary actions), gaining data regarding users that can be used to better target advertising, etc. The data packet 104 can enable affiliate, viral, and/or WOM advertising in an ecosystem independent environment, as the data packet 104 can be propagated throughout a community network to different sites based in part on user actions. The ad object 102, data packet 104, CSC 106, and interface 108 can function as more fully described herein, for example, with regard to other system(s) disclosed herein (e.g. system 100, system 200, system 300, system 500, system 600).

For example, the data packet 104 can receive, from the community network 402, a portion of data associated with advertisements for products/services, and actions associated therewith performed by users, as well as other use activity data. The data packet 104 can store such data, and can accumulate such data as it is reproduced in sites throughout the community network 402. For example, the data packet 104 can be embedded in a blog associated with network 402 and can receive data in the form of community metadata from user(s) associated with the network 402. The data packet 104 can add such community metadata to its data string. The data packet 104 can be reproduced in a web site of another user via a syndication action performed by the other user. The data packet 104 can have all the data that it contained before being copied to the web site of the other user. Further, any additional data received by the data packet 104 while embedded on the web site can also be added to the data packet 104.

A data packet 104 can provide data contained therein to a CSC 106 which can receive and analyze the such data and can facilitate processing actions, such as primary actions, of users, for example, to process purchases associated with the data packet 104 that can be made by users. The CSC 106 can facilitate determining an incentive 110 that can be provided to a user based on the actions of the user and/or conversions associated with the user.

Furthermore, the ad object 102 and data packet 104 can interact with a community network 402. The community network 402 can include most any suitable number of clients 404, such as client ₁ to client _{N}, where N is a positive integer, that can be associated with the community network 402. The client(s) can be merchant(s), advertiser(s), retailer(s), wholesaler(s), etc. that can facilitate generation of online advertisements, and/or ad objects 102 respectively associated therewith, related to products, services, and/or other commerce.

The community network 402 also can include most any suitable number of users 406, such as user ₁ to user _{M}, where M is a positive integer. A user 406 can be an entity that can manipulate or interact with an ad object(s) 102, perform desired action(s) (e.g., primary, community, and/or syndication actions) with regard to advertisements and products or services marketed associated therewith, for example. It is to be appreciated that the data packet 102 and/or CSC 106 can differentiate between respective users 406 as well as between respective clients 404 in the community network 402.

In one example, the community network 402 can be a network associated with commerce and/or transactions related to commerce such as buying an item, a product, and/or service; selling an item, a product, and/or service; buying a portion of an item, a product, and/or a service; selling a portion of an item, a product, and/or a service, etc. The ad object 102 and data packet 104 can receive data from the community network 402 in order to facilitate processing of primary actions (e.g., purchases) as well as gleaning information regarding users, which can be used to better target advertising to users. Further, the data packet 104 can provide such data to CSC 106, which can receive and analyze such data, and other data contained in data packet 104, and can facilitate processing the user actions and/or determining incentives 110 that can be provided to users. It is to be appreciated that community network 402 can be comprised of one or more disparate networks that can cooperate and communicate with each other.

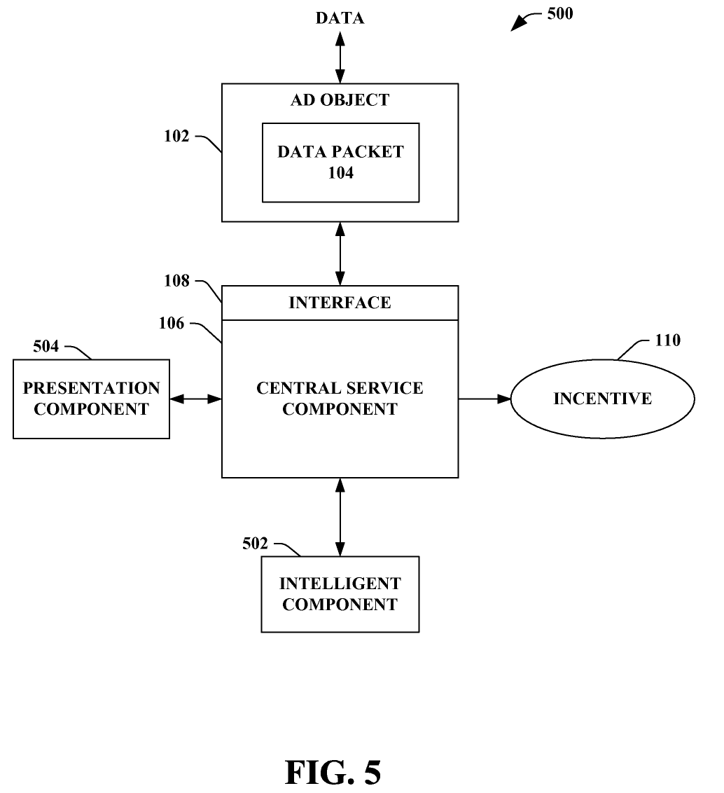

FIG. 5 illustrates a system 500 that can employ intelligence to facilitate marketing products and/or services in accordance with the disclosed subject matter. The system 500 can include the ad object 102, data packet 104, CSC 106, and interface 108, wherein it is to be appreciated that such components and/or interfaces, and other components and/or interfaces, can be substantially similar to respective components and/or interfaces described with regard to other system(s) disclosed herein (e.g., system 100, system 200, system 300, system 400, system 600). The system 500 can further include an intelligent component 502. The intelligent component 502 can be utilized by the CSC 106 to facilitate analyzing data to determine whether actions have been performed by users, ratings or reputation scores, an amount and/or a type of incentive that can be awarded to a user, the status of a data packet 104 with regard to its lifespan and/or referral chain, etc.

For example, the intelligent component 502 can infer whether a user has performed an action (e.g., primary action) associated with an advertisement or associated ad object 102; ratings and/or reputation scores; an amount and/or a type of incentive; a status of a data packet 104 related to the lifespan of the packet 104, and/or a status of a data packet 104 related to its referral chain.

It is to be understood that the intelligent component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data (e.g., historical data), whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The CSC 106 can further utilize a presentation component 504 that provides various types of user interfaces to facilitate interaction between a user and any component coupled to the CSC 106. As depicted, the presentation component 504 is a separate entity that can be utilized with the CSC 106. However, it is to be appreciated that the presentation component 504 and/or similar view components can be incorporated into the CSC 106 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the CSC 106.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

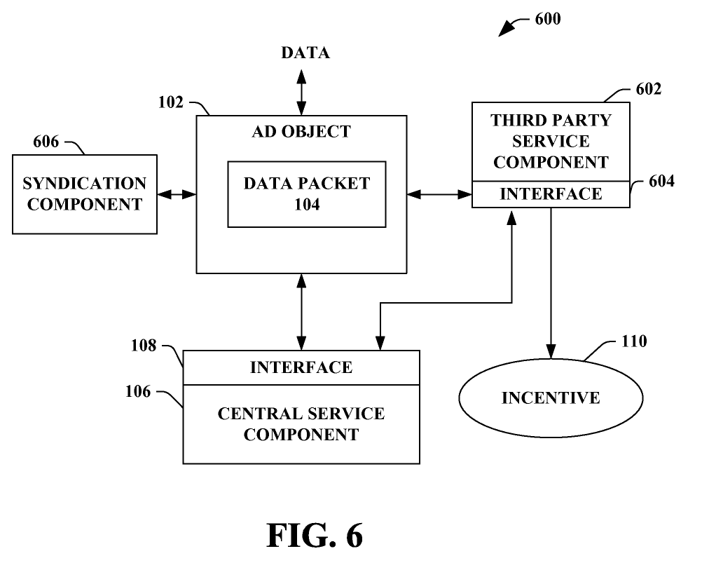

FIG. 6 illustrates a system 600 that can facilitate marketing products and/or services in accordance with the disclosed subject matter. The system 600 can include the ad object 102, data packet 104, CSC 106, and interface 108, wherein it is to be appreciated that such components and interfaces, and other components and interfaces, can be substantially similar to respective components and interfaces described with regard to other systems disclosed herein (e.g., system 100, system 200, 300, system 400, system 500). System 600 can gather data associated with users, user activity, advertisements, products, services, primary actions, community actions, syndication actions, object metadata, and/or other data.

The system 600 can further include a third party service component 602. The third party service component 602 can be utilized to perform a portion of the functions associated with the CSC 106, as such functions have been more fully described herein. For example, third party service component 602 can receive data via interface component 604 from ad object 102 and data packet 104 and can analyze such data to facilitate processing of transactions associated with primary actions performed by users, determining incentives 110 that can be awarded to users, identifying and/or authenticating users, as well as other functions that can be delegated to the third party service component 602. The third party service component 602 can be associated with CSC 106 and data can be transferred between third party service component 602 and CSC 106 via their respective interfaces 604 and 108.

System 600 can further include a syndication component 606 that can facilitate reproducing an ad object 102 in another site (e.g., web site, blog, e-mail, instant message, etc.) to facilitate propagating the ad object 102 and data packet 104 through a community network. The syndication component 606 can be and/or can include a control or mechanism that, when manipulated, can generate or reproduce an ad object 102 and associated data (e.g., data packet 104, associated advertisement, etc.) to another site that can be associated with a syndicating user. The syndication component 606 can also facilitate adding data regarding the syndication action to the data packet 104, where such added data can include data identifying the syndicating user, the site of the user, and/or the time of syndication, for example.

In accordance with one embodiment of the disclosed subject matter, the syndication component 606 can be associated with an ecosystem (not shown). For example, an ecosystem can be and/or can include a web site that can be associated with a merchant, an online service provider, and/or other entity, and can include one or more ad objects 102. As further example, the syndicating user can manipulate the syndication component 606 associated with the ecosystem to reproduce the ad object 102 on the user's web site or blog, and/or to have the syndication component 606 generate an e-mail, instant message, and/or other form of electronic communication that can have the ad object 102 reproduced therein, and the e-mail, instant message, or other electronic communication can be sent to another user(s) to whom the syndicating user specifies therein.

In accordance with another embodiment of the disclosed subject matter, the syndication component 606 can be associated with a browser (not shown) to facilitate syndication of an ad object 102. For example, the browser can include a syndication component 606 that can facilitate reproducing the ad object 102 into another site. As another example, the syndication component 606 can include mechanisms that can facilitate copying the ad object 102 and its content (e.g., data packet 104) and pasting the ad object 102 and content into a site associated with the syndicating user to syndicate the ad object 102.

In accordance with yet another embodiment of the disclosed subject matter, the syndication component 606 can be associated with an application (not shown) and can reproduce the ad object 102 into another site. For example, an application can be an online mail application that can include a syndication component 606 that can facilitate forwarding a received message(s), such as an e-mail(s), that can include the ad object 102 and associated data, to other entities (e.g., users). A user can receive an ad object 102 in a message, and can manipulate the syndication component 606 to facilitate syndicating the ad object 102, for example, by forwarding the message, including the ad object 102, to another user(s). As another example, an application can include a syndication component 606 that can facilitate copying the ad object 102, including associated data (e.g., data packet 104), and pasting the ad object 102 into another form of electronic communication (e.g. web site, blog, e-mail, instant message, etc.) to syndicate the ad object 102.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

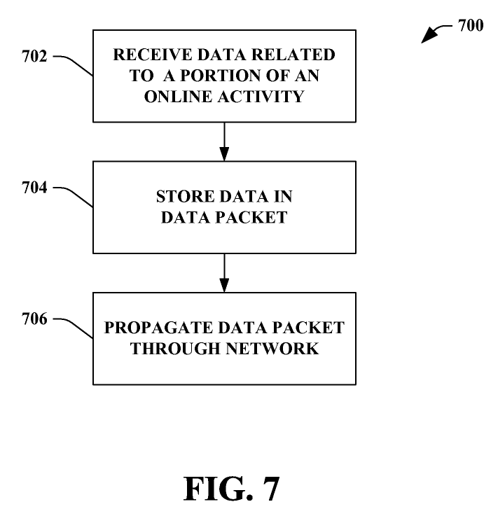

FIGS. 7-12 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, depicted is a methodology 700 that can facilitate marketing products and/or services in accordance with the disclosed subject matter. At 702, data, or a portion thereof, associated with user(s), user activity, advertisement(s), content, primary action(s), community action(s), syndication action(s), community metadata, object metadata, incentive(s), etc. can be received by the data packet 104. At 704, the received data can be stored and/or added to the data packet 104. For example, the received data can be added to a corresponding portion of a data string associated with the data packet 104 based in part on the type of data received. At 706, the data packet 104 can be propagated through a community network. For example, the data packet 104 can be included in an ad object 102 and associated with an advertisement for product(s) and/or service(s). The data packet 104 can be propagated throughout the community network to various sites based on actions performed on the ad object 102 and data packet 104 by users in the community network. Methodology 700 can return to 702, as the data packet 104 can receive and accumulate data as the data packet 104 is moves through the community network. The data packet 104 can be propagated through the network in an ecosystem independent manner, as there is virtually no restriction with regard to where the data packet 104 can be propagated. At this point, methodology 700 can end.

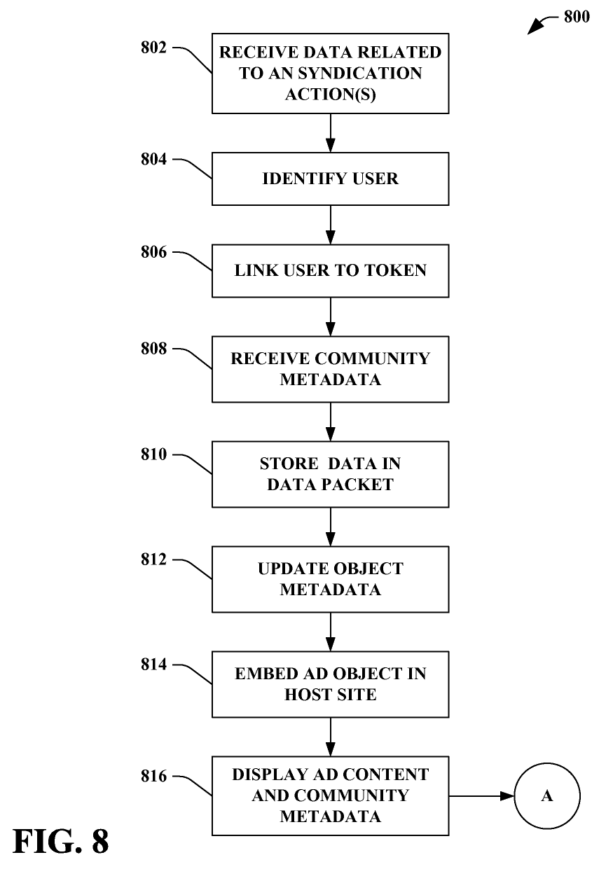

Referring to FIG. 8, illustrate is a methodology 800 that can facilitate syndicating an ad object and/or associated data packet in accordance with the disclosed subject matter. At 802, data, or a portion thereof, related to a syndication action, or a portion thereof, can be received, for example, by the ad object 102. The received information can include data contained in the data packet 104, including data associated with the manipulation of the syndication control associated with the ad object 102, the advertisement, the product or service, etc. The syndication action(s) can be associated with the ad object 102, where the ad object 102 can be associated with an advertisement that can promote a product(s) and/or service(s). A user(s) can view an ad object 102 and/or associated advertisement in one location (e.g., web site, blog, etc.) and can manipulate (e.g., mouse click, keystroke, voice command, etc.) the ad object 102, or a control associated therewith, for example, to syndicate, publish, and/or reproduce the ad object 102, associated data packet 104, and/or associated advertisement, in another location associated with the user. In accordance with various other embodiments of the disclosed subject matter, a syndication component (e.g., 606) can be included in and/or associated with an ecosystem, a browser, and/or an application, to facilitate reproducing an ad object 102 and/or associated data (e.g., data packet 104, advertisement, etc.), into another site (e.g., location) associated with the user.

At 804, the user performing the syndication action can be identified by the ad object 102. If the user has not been authenticated, the user can be requested to authenticate via a common identity service. Data that can identify the user can be received by the ad object 102, for example, at 802.

At 806, the user can be linked to a unique token identifier so that the user and the syndication action performed by the user can be identified by the ad object 102 and/or CSC 106. At 808, the data packet 104 can receive community metadata (e.g., comments), if any, from the user. At 810, received data can be added to and/or stored in the data packet 104. For example, the received data can be placed in a corresponding portion of a data string associated with the data packet 104.

At 812, the object metadata can be updated. For example, the referral chain depth can be incremented by one and/or the total number of syndication actions can be incremented by one. The referral chain can be updated to reflect the new location of the ad object 102 and data packet 104.

At 814, the ad object 102 and associated data packet 104 can be embedded in the new location associated with the syndication action. At 816, the advertisement, ad object 102 associated therewith, and/or any community metadata provided by the user can be displayed in the new location. At this point, methodology 800 can end.

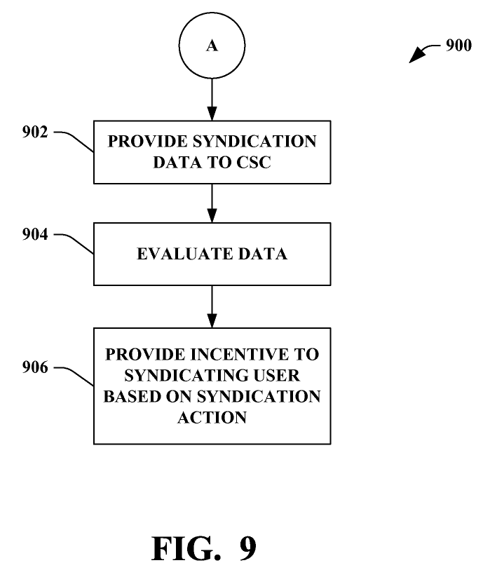

Turning to FIG. 9, a methodology 900 that can facilitate providing an incentive to a user based on a syndication action is illustrated. At point A, from methodology 800, it can be determined that the user performed a syndication action to reproduce an ad object 102 and associated data packet 104 in a location associated with the user. At 902, data, or a portion thereof, related to a syndication action(s), or a portion thereof, can be provided, for example, by data packet 104 to CSC 106. The data can be associated with the user performing such syndication action, an advertisement associated with the syndication action, the type of location (e.g., web site, blog, e-mail, etc.) where the ad object 102 has been published or reproduced, object metadata (e.g., incentive information), etc.

At 904, the data received by the CSC 106 can evaluate the data to determine the amount of incentive that the user can be awarded for performing a syndication action with regard to the syndication action. At 906, the CSC 106 can provide the appropriate incentive to the user based in part on the syndication action performed by the user. At this point, methodology 900 can end.

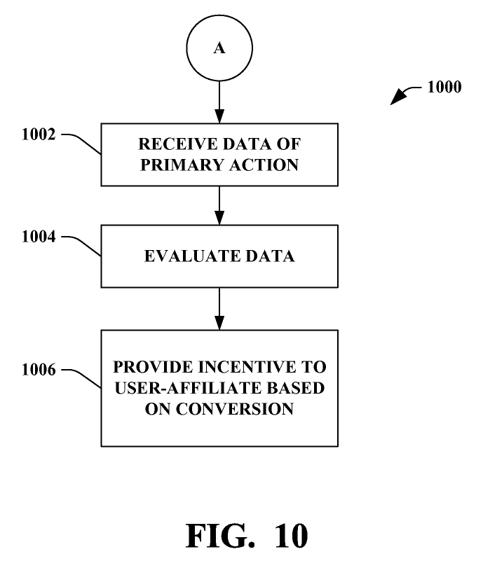

Turning to FIG. 10, a methodology 1000 that can facilitate providing an incentive to a user based on a conversion is illustrated. At point A, from methodology 800, it can be determined that the user performed a syndication action to reproduce an ad object 102 and associated data packet 104 in a location associated with the user. At 1002, data, or a portion thereof, related to a primary action(s), or a portion thereof, performed by another user in relation to the ad object 102 syndicated by the user (e.g., affiliate) syndicating such ad object 102 can be provided, for example, by data packet 104 to CSC 106. The data can be associated with the user-affiliate performing such syndication action, the advertisement associated with the syndication action, the type of location (e.g., web site, blog, e-mail, etc.) where the ad object 102 has been published or reproduced, the other user, the primary action performed by the other user, object metadata (e.g., incentive information), etc.

At 1004, the data received by the CSC 106 can be evaluated to determine the amount of incentive that the user-affiliate can be awarded for the conversion associated with the primary action performed by the other user in relation to the advertisement, and ad object 102 associated therewith. At 1006, the CSC 106 can provide the appropriate incentive to the user-affiliate based in part on the syndication action performed by the user-affiliate and/or the conversion associated with the primary action performed by the other user in relation to the ad object 102 on the site of the user-affiliate. At this point, methodology 1000 can end.

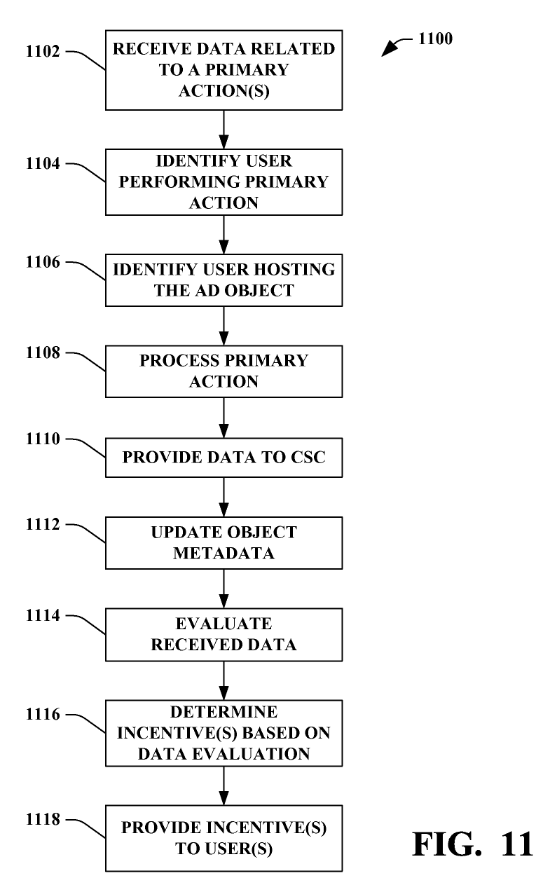

Referring to FIG. 11, a methodology 1100 that can facilitate providing an incentive to a user based on a primary action is illustrated. At 1102, data, or a portion thereof, related to a primary action, or a portion thereof, can be received, for example, by the ad object 102. The received information can include data contained in the data packet 104, including data associated with the manipulation of the primary-action control associated with the ad object 102, the advertisement, the product or service, etc. The primary action(s) can be associated with the ad object 102, where the ad object 102 can be associated with an advertisement that can promote a product(s) and/or service(s). A user(s) can view an ad object 102 and/or associated advertisement in one location (e.g., web site, blog, etc.) and can manipulate (e.g., mouse click, keystroke, voice command, etc.) the ad object 102, or a control associated therewith, for example, to perform a primary action (e.g., purchase, download, etc.) associated with the product(s) and/or service(s) marketed by the advertisement.

At 1104, the user performing the primary action can be identified by the ad object 102. If the user has not been authenticated, the user can be requested to authenticate via a common identity service. Data that can identify the user can be received by the ad object 102, for example, at 1102.

At 1106, the user-affiliate hosting the ad object 102 can be identified. The user-affiliate can be identified based on a unique token identifier that can be associated with the user-affiliate when the user-affiliate syndicated the advertisement and associated ad object 102. Information identifying the user-affiliate can be contained in the data packet 104. At 1108, the primary action can be processed. In accordance with one embodiment of the disclosed subject matter, the primary action can be processed while the user is still at the site hosting the ad object 102. In accordance with another embodiment, the user can be re-directed to another site, such as the advertiser's web site or a third-part site associated therewith, to process the primary action. At 1110, the data packet 104 can receive the data associated with the primary action which can be added to the data packet 104, and the CSC 106 can access such data from the data packet 104 to facilitate processing the primary action, while such data remains stored in data packet 104. The data packet 104 and CSC 106 can work in conjunction with each other to facilitate processing the primary action.

At 1112, the ad object metadata can be updated to reflect the primary action being performed. For example, the data packet 104 can add object metadata to the data packet 104 to increment the total number of actions taken with regard to the ad object 102 and/or the increment the total number of primary actions associated with the ad object 102. For example, an ad object 102 and data packet 104 can have a limit as to the number of primary actions that can be processed that result in an incentive being provided to the user performing the primary action. Once the predetermined limit has been reached, the ad object 102 and data packet 104 can reflect that the incentive is no longer available, although a primary action can still be performed.

At 1114, the CSC 106 can evaluate the data received from data packet 104. At 1116, the CSC 106 can determine a type and/or an amount of incentive that can be awarded to the user performing the primary action. The type and/or amount of incentive can be based on the user, the advertisement, the product(s), the service(s), the data packet 104, the type of primary action that was performed, etc. At 1118, the incentive determined at 1116 can be provided to the user. For example, such incentive can be deposited in the account associated with the user. At this point, methodology 1100 can end.

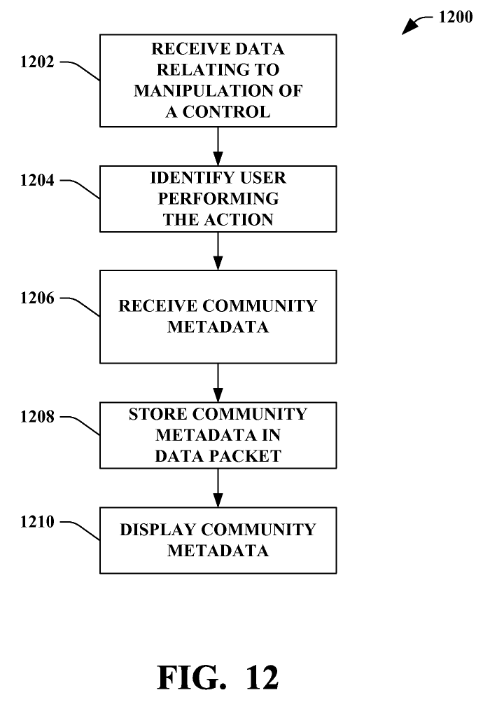

FIG. 12 illustrates a methodology 1200 that can facilitate storing community metadata in a data packet in accordance with the disclosed subject matter. At 1202, data, or a portion thereof, related to a manipulation of a community control associated with an ad object 102 can be received by the data packet 104. For example, a user can initiate a community action by manipulating a community control associated with the ad object 102 in order to provide community metadata (e.g., comment, review, rating, etc.) regarding the advertisement, and/or the product and/or service marketed therein. At 1204, the user performing the community action (e.g., manipulating the community control) can be identified. The user can be identified by the user's identification/authentication information the user can provide when logging into the community network. If the user has not logged into the network prior to the manipulating the community control, the user can be requested by the ad object 102 and/or CSC 106 to authenticate via a common identity service, so that the user can be identified.

At 1206, data, or a portion thereof, associated with community metadata can be received by the data packet 104. For example, the user can provide a review of the product being promoted in the advertisement. At 1208, the data packet 104 can store or add the community metadata to the data packet 104. For example, the community metadata can be contained in a portion of a data string associated with the data packet 104. In accordance with another aspect of the disclosed subject matter, the community metadata can be shared with the CSC 106, as the data packet 104 can provide such data to the CSC 106. At 1210, the stored community metadata can be displayed or presented with the advertisement and/or ad object 102, so users in the community network can view such community metadata when viewing the advertisement. At this point, methodology 1200 can end.

It should be appreciated that the methodologies disclosed herein and throughout this specification are capable of being stored on an article of manufacture to facilitate transporting and transferring such methodologies to computers. The term article of manufacture, as used herein, is intended to encompass a computer program accessible from any computer-readable device, carrier, or media.

It should also be appreciated that some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

Further, it has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

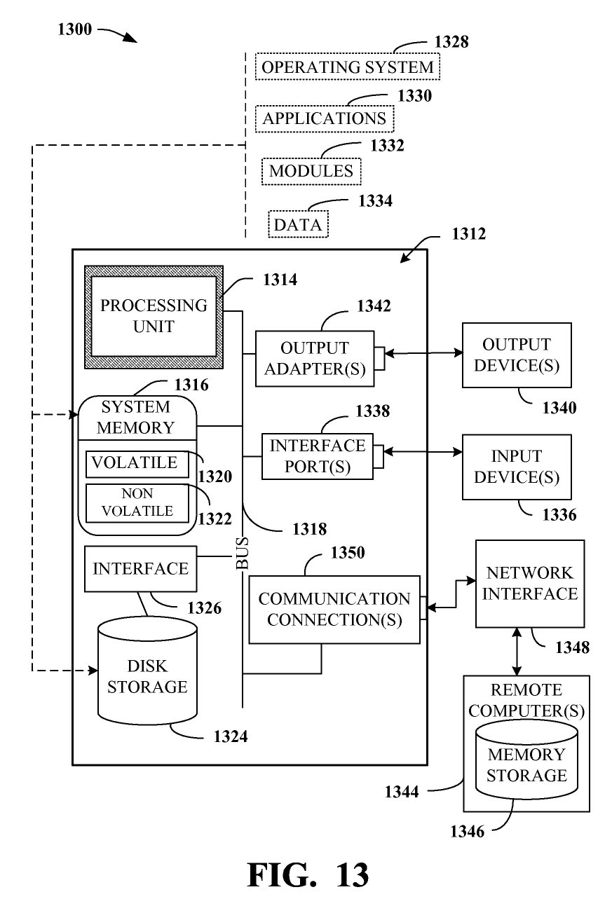

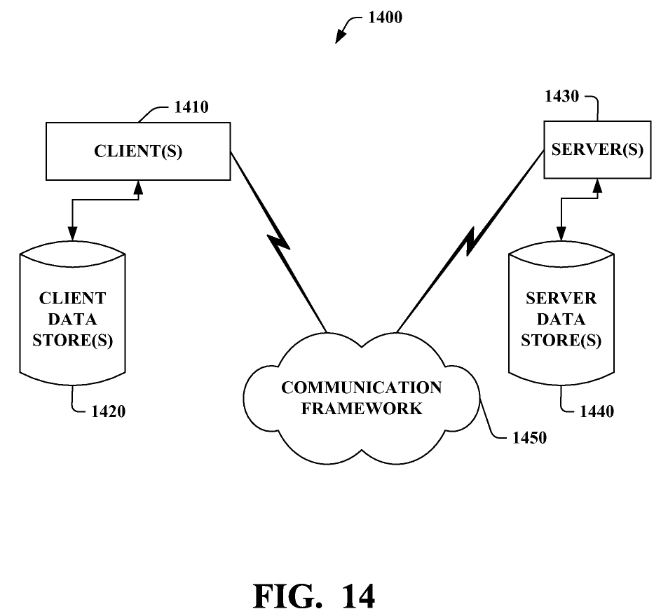

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 13, a suitable environment 1300 for implementing various aspects of the claimed subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example, a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used, such as interface 1326.

It is to be appreciated that FIG. 13 describes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the claimed subject matter can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1420 that can be employed to store information local to the client(s) 1410. Similarly, the server(s) 1430 are operatively connected to one or more server data store(s) 1440 that can be employed to store information local to the servers 1430.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates promotion of products or services, comprising:
a data packet that receives and accumulates data associated with at least one advertisement associated with at least one of a product or a service, or a combination thereof, as the data packet propagates through a community network, to facilitate at least one of a promotion of the product or the service, an accumulation of data associated with at least one user that interacts with the at least one advertisement, an analysis of received data to learn about the at least one user, or a determination relating to an incentive to be awarded to the at least one user, or a combination thereof.

2. The system of claim 1, further comprising a central service component that is associated with the data packet and receives the data associated with the at least one advertisement, analyzes the received data, compares the received data to a subset of incentive criteria, and makes a determination regarding at least one of a type or an amount of incentive to be awarded to the at least one user based on the incentive criteria.

3. The system of claim 1, the data packet is associated with an ad object that can facilitate displaying data contained within the data packet.

4. The system of claim 3, the data packet receives and accumulates data associated with ad object metadata comprising at least one of a referral chain associated with the data packet, a lifespan of the data packet, or an incentive associated with the at least one advertisement, or a combination thereof.

5. The system of claim 1, the data packet is comprised of a piece of code.

6. The system of claim 1, the data packet receives and accumulates data comprising community metadata that is associated with at least one of a reputation, a rating, a review, a comment, or a tag, or a combination thereof, associated with the at least one advertisement.

7. The system of claim 1, the at least one advertisement comprising content associated with the at least one of a product or a service, or a combination thereof, the content comprising at least one of a viral agent, promotional content, or community metadata, or a combination thereof.

8. The system of claim 1, further comprising a data store that can store data associated with the at least one advertisement.

9. The system of claim 1, further comprising a common identity service component that identifies and verifies the identification of the at least one user.

10. The system of claim 1, further comprising a community network that is associated with the data packet or the central service component, or a combination thereof, the community network provides information to the data packet or the central service component, or a combination thereof.

11. The system of claim 1, further comprising an intelligent component that makes an inference as to at least one of whether an action has been performed by the at least one user, a rating, a reputation, a type of incentive, an amount of incentive, a status of a data packet with regard to a referral chain, or a status of a data packet with regard to lifespan, or a combination thereof.

12. The system of claim 1, the at least one advertisement and the data packet are contained in at least one of a web site, a web page, a webfeed, a blog, an e-mail, an instant message, a short message service, a multimedia messaging service, an enhanced messaging service, or a combination thereof.

13. At least one computer that comprises the central service component of claim 2.

14. A method that facilitates marketing products or services, comprising:
receiving a subset of information associated with at least one advertisement marketing at least one of a product or service, or a combination thereof;
storing the subset of information in at least one data packet; and
propagating the at least one data packet across a community network.

15. The method of claim 14, further comprising:
analyzing the subset of information; and
determining at least one of a type or an amount of incentive to award to a user based on incentive criteria and the subset of information.

16. The method of claim 14, further comprising:
receiving information associated with a manipulation of a control, the control is at least one of a primary-action control, a community control, or a syndication control;
reproducing the at least one data packet in an online location associated with a user when a syndication control is manipulated by the user;
processing a primary action when a primary-action control is manipulated by a user; and
receiving community metadata when a community control is manipulated by a user.

17. The method of claim 14, further comprising:
receiving content, the content comprising at least one of a viral agent, promotional content, or community metadata, or a combination thereof, the content is associated with the at least one of a product or service, or a combination thereof; and
displaying the content as part of the at least one advertisement.

18. The method of claim 14, further comprising:
accumulating data in the at least one data packet as the at least one data packet propagates across a community network; and
communicating the accumulated data to a central service component.

19. A system that facilitates promotion of products or services, comprising:
means for receiving information in a data packet, the information is associated with at least one advertisement related to at least one product or service, or a combination thereof;
means for propagating the data packet across one or more disparate ecosystems associated with at least one network; and
means for accumulating the information within the data packet as the data packet is propagated to facilitate at least one of processing at least one action associated with at least one user with regard to the at least one advertisement, gaining knowledge regarding the at least one user, or providing an incentive to the at least one user, or a combination thereof, the at least one action comprising at least one of a primary action, a community action, or a syndication action.

20. The system of claim 19, further comprising:
means for identifying at least one user;
means for displaying the at least one advertisement in a site;
means for processing at least one action associated with the at least one user;
means for enabling the at least one user to reproduce the data packet in a disparate site;
means for enabling the at least one user to provide community metadata associated with the at least one advertisement;
means for determining at least one of a type or an amount of incentive, or a combination thereof; and
means for distributing the incentive to an account associated with the user.
